(19) United States
(12) Patent Application Publication
(10) Pub. No.: US 2026/0254762 A1
(43) Pub. Date: Aug. 27, 2026

(54) TIME-STAMPING NODE, INTERMEDIATE NODE AND METHODS PERFORMED THEREIN

(71) Applicant: Telefonaktiebolaget LM Ericsson (publ), Stockholm (SE)

(72) Inventors: Harald GUSTAFSSON, Lund (SE); Alexey SHAPIN, Luleå (SE); Henning WIEMANN, Aachen (DE); Jonathan LYNAM, San Jose, CA (US); Joachim SACHS, Sollentuna (SE); G¿ran RUNE, Linköping (SE)

(21) Appl. No.: 18/870,712

(22) PCT Filed: Jun. 3, 2022
(86) PCT No.: PCT/SE2022/050547

§ 371 Date: Dec. 2, 2024

(51) Int. Cl. H04L 47/28; H04W 28/02

(52) U.S. Cl. CPC H04L 47/28; H04W 28/0236

(57) ABSTRACT

A method performed by a time-stamping node for handling communication in a communication network. The time-stamping node provides an indication of a required DT to a packet, wherein the DT is related to an upper latency limit of the packet along a path between two end-nodes. The time-stamping node further transmits the packet with the DT towards an end-node in the communication network.

### TECHNICAL FIELD

Embodiments herein relate to a time-stamping node, an intermediate node and methods performed therein. Furthermore, a computer program and a computer readable storage medium are also provided herein. In particular, embodiments herein relate to handling communication in a communication network.

### BACKGROUND

In a typical communication network, User Equipment (UE), also known as wireless communication devices, mobile stations, Stations (STA) and/or wireless devices, communicate via a Radio Access Network (RAN) to one or more Core Networks (CNs). The RAN covers a geographical area which is divided into service areas or cell areas, with each service area or cell area being served by a radio network node such as a radio access node e.g., a Wi-Fi access point or a Radio Base Station (RBS), which in some networks may also be denoted, for example, a NodeB, an eNodeB”, or a gNodeB. A service area or cell area is a geographical area where radio coverage is provided by the radio network node. The radio network node communicates over an air interface operating on radio frequencies with the wireless device within range of the radio network node.

A Universal Mobile Telecommunications System (UMTS) is a Third Generation (3G) telecommunication network, which evolved from the Second Generation (2G) Global System for Mobile Communications (GSM). The UMTS Terrestrial Radio Access Network (UTRAN) is essentially a RAN using Wideband Code Division Multiple Access (WCDMA) and/or High-Speed Packet Access (HSPA) for UE. In a forum known as the Third Generation Partnership Project (3GPP), telecommunications suppliers propose and agree upon standards for third generation networks and investigate enhanced data rate and radio capacity. In some RANs, e.g. as in UMTS, several radio network nodes may be connected, e.g., by landlines or microwave, to a controller node, such as a Radio Network Controller (RNC) or a Base Station Controller (BSC), which supervises and coordinates various activities of the plural radio network nodes connected thereto. This type of connection is sometimes referred to as a backhaul connection. The RNCs and BSCs are typically connected to one or more CNs.

Specifications for the Evolved Packet System (EPS) have been completed within the 3GPP and this work continues in the coming 3GPP releases. The EPS comprises the Evolved Universal Terrestrial Radio Access Network (E-UTRAN), also known as the Long-Term Evolution (LTE) RAN, and the Evolved Packet Core (EPC), also known as System Architecture Evolution (SAE) core network. E-UTRAN/LTE is a variant of a 3GPP radio access technology wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes which can be connected directly to one or more core networks, i.e. they do not need to be connected to the core via RNCs.

With the emerging 5G technologies such as New Radio (NR), the use of a large number of transmit-and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify received signals coming from a selected direction or directions, while suppressing received unwanted signals coming from other directions.

Even though a certain application may have a certain latency requirement, for a network to fulfil, sometimes the application uses less of its time, leaving a bit more of a total latency budget to the network. So instead of the application/UE/service just buffering the data until the transmission window opens, this time may be better spent by the network.

By itself, even with a delay budget header/marking, there may only be a rough idea of the remaining budget, but unless being a Radio Base Station (RBS), it may also be necessary to know the estimated time required by any remaining downstream nodes. For example, if a delay budget has 5 milliseconds (ms) remaining and there are 3 more network hops, it may be useful to know the deadline to forward the packet. Previously this may be accomplished in several ways:
1. Using Two-Way Active Management Protocol (TWAMP)-like protocols, in a multi-hop approach along a path to a destination. This works like a traceroute, providing timing information to each hop, but very precisely. So, each node would estimate the latency of the remaining downlink path.
2. The delay budget header/marking in the packet may actually be a vector of timing requirements, for each hop.

In “learning mode”, each node may add a row with their packet receive timestamp and adds it to the header. When an application, e.g. at a UE, receives this header, it may compute a downlink budget remaining for every node. This information may be sent, out-of-band, to a server part of the application. Subsequent packets sent by the server may add the delay budget header in “strict mode”, where a downlink budget for each node is specified in the vector.

### SUMMARY

An object of embodiments herein is to provide a mechanism for handling data communication in a communication network in an efficient manner.

According to an aspect of embodiments herein the object may be achieved by a method performed by a time-stamping node for handling communication in a communication network. The time-stamping node provides an indication of a required delivery time (DT) to a packet, wherein the DT is related to an upper latency limit of the packet along a path between two end-nodes. The time-stamping node further transmits the packet with the DT towards an end-node in the communication network.

According to another aspect of embodiments herein the object may be achieved by a method performed by an intermediate node for handling communication in a communication network. The intermediate node receives a packet comprising an indication of a required DT. The intermediate node then further determines one or more transmission parameters based on the DT. The intermediate node further transmits the packet with the DT towards an end-node in the communication network, based on the determined one or more transmission parameters.

According to a further aspect of embodiments herein, the object is achieved by providing a time-stamping node for handling data communication in a communication network. The time-stamping node is configured to provide an indication of a required DT to a packet, wherein the DT is related to an upper latency limit of the packet along a path between two end-nodes. The time-stamping node is further configured to transmit the packet with the DT towards an end-node in the communication network.

According to yet a further aspect of embodiments herein, the object is achieved by providing an intermediate node for handling data communication in a communication network. The intermediate node is configured to receive a packet comprising a required DT. The intermediate node is further configured to determine one or more transmission parameters based on the DT. The intermediate node is further configured to transmit the packet with the DT towards an end-node in the communication network, based on the determined one or more transmission parameters.

It is furthermore provided herein a computer program comprising instructions, which, when executed on at least one processor, cause the at least one processor to carry out the method above, as performed by the network node. It is additionally provided herein a computer-readable storage medium, having stored thereon a computer program comprising instructions which, when executed on at least one processor, cause the at least one processor to carry out the method above, as performed by the time-stamping node or the intermediate node, respectively.

Embodiments herein are based on the realisation that when a UE or network node achieve its transmission ahead of time, there is a certain amount of latency buffer that was reserved but not needed. A DT can therefore be provided to a packet by a time-stamping node, which packet is then transmitted towards an end-node. An intermediate node receives the packet comprising the DT and adapts the transmission parameters. The DT that was not needed may instead be utilized for more efficient network usage. Thereby the communication in the communication network is handled in an efficient manner.

### BRIEF DESCRIPTION OF THE DRAWINGS

Embodiments will now be described in more detail in relation to the enclosed drawings, in which:

FIG. 1 is a schematic overview depicting a communication network according to embodiments herein;

FIG. 2 is a schematic overview illustrating an example of handling communication in a communication network, according to embodiments herein;

FIG. 3 is a flowchart depicting a method performed by a time-stamping node according to embodiments herein;

FIG. 4 is a flowchart depicting a method performed by an intermediate node according to embodiments herein;

FIG. 5a is a schematic overview illustrating an example of handling of a delivery time in downlink.

FIG. 5b is a schematic overview illustrating an example of handling of a delivery time in uplink.

FIG. 6 is a block diagram depicting a time-stamping node according to embodiments herein;

FIG. 7 is a block diagram depicting an intermediate node according to embodiments herein;

FIG. 8 schematically illustrates a telecommunication network connected via an intermediate network to a host computer;

FIG. 9 is a generalized block diagram of a host computer communicating via a base station with a user equipment over a partially wireless connection; and

FIGS. 10 to 13 are flowcharts illustrating methods implemented in a communication system including a host computer, a base station and a user equipment.

### DETAILED DESCRIPTION

Embodiments herein may be considered both from a single UE, e.g. an Ultra-Reliable Low Latency Communication (URLLC) UE, context or as a resource management of multiple UE, e.g. multiple URLLC UE, the later allowing some oversubscription of resources.

From a single UE's perspective embodiments herein may allow:
More efficient radio encoding, taking somewhat longer time.
This may in a multiple UE scenario allow more radio resources to other UE.
More robust radio encoding, ensuring higher transmission probability.

In the context of many UE, when many UE are typically achieving their transmission ahead of time, there is a certain amount of latency buffer, i.e. transmission resources that were reserved for the UE, but not needed. If resource allocations that were reserved for one UE but are not needed, could very quickly be reallocated to another UE, then the latency buffer could be planned in the resource allocation. It may be hard to benefit from that in e.g. admission control since:
a) no node along the path knows which share of the End-to-End (e2e) delay budget it may really consume; and
b) an estimated time that each hop may consume is just a worst-case assumption, in most cases the actual delay is lower.

Embodiments herein may be very useful for real-time video streaming, where video encoders may take an unpredictable amount of time to encode a frame. This is in the range of 500 microseconds-5 ms depending on parameters. Often the application will need to prepare for a worst-case encoding time. However, the worst cases may tend to only happen during scene changes which are random and relatively infrequent.

So often there may be several 1-3 ms of delay tolerance or “slack” in delivering the frame. There is thus a need to signal that to the network.

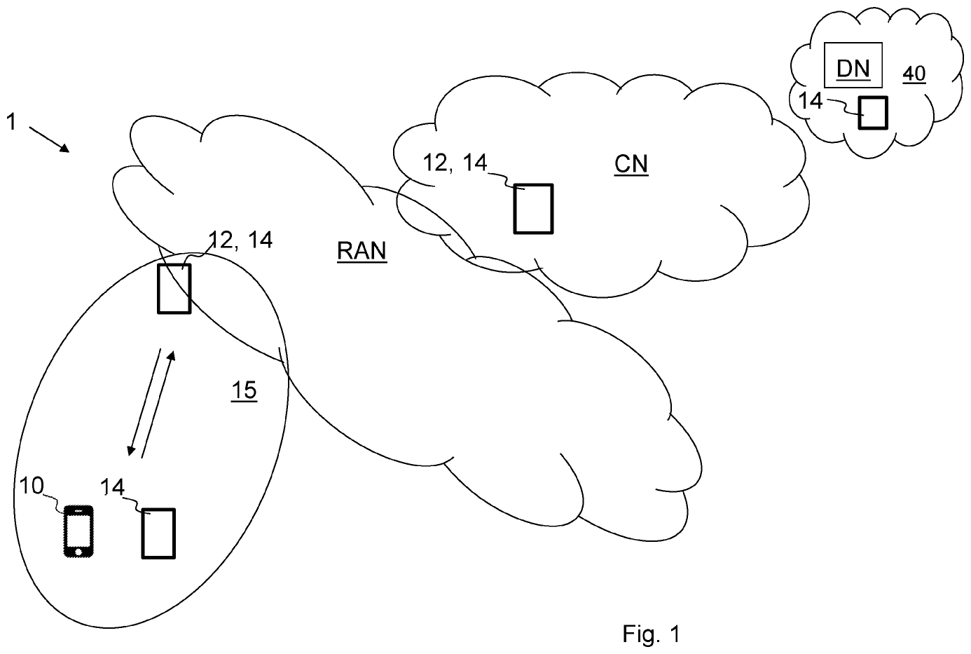

Embodiments herein relate to communication networks in general. FIG. 1 is a schematic overview depicting a communication network 1. The communication network 1 comprises one or more RANs connected to one or more CNs. The communication network 1 may use a number of different technologies, such as Wi-Fi, Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are applicable also in further development of the existing communication systems such as e.g. a WCDMA and or LTE system.

In the wireless communication network 1, wireless devices e.g. a UE 10, a mobile station, a non-Access Point (non-AP) Station (STA), a STA, and/or a wireless terminal, communicate via one or more Access Networks (AN), e.g. RAN, to one or more CNs. It should be understood by the skilled in the art that “UE” is a non-limiting term which means any terminal, wireless communication terminal, user equipment, Machine Type Communication (MTC) device, Device to Device (D2D) terminal, Internet of Things (IoT) operable device, or node e.g. smart phone, laptop, mobile phone, sensor, relay, mobile tablets or even a small base station capable of communicating using radio communication with a network node within an area served by the network node.

The communication network 1 comprises a network node, such as an intermediate node 12, e.g. a radio network node, providing e.g. radio coverage over a geographical area, a service area 15, e.g. one or more cells, of a radio access technology (RAT), such as NR, LTE, Wi-Fi, WiMAX or similar. The intermediate node 12 may be a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point, network internal nodes such as a User Plane Function (UPF), a Central Unit-User Plane (CU-UP), a Distributed Unit (DU) or any other network unit or node depending e.g. on the radio access technology and terminology used. The intermediate node 12 may alternatively or additionally be a controller node or a packet processing node or similar. The intermediate node 12 may be referred to as source node, source access node or a serving network node. The intermediate node 12 may be a UE. The intermediate node 12 may be a distributed node comprising a baseband unit and one or more remote radio units.

The communication network 1 comprises a time-stamping node 14. The time-stamping node 14 may be a UE, e.g. an application client or application server located e.g., in a cloud 40, a RAN or a CN, or a network node. When the time-stamping-node is a UE, the intermediate node 12 may communicate with the time-stamping node 14 in form of downlink (DL) transmissions to the time-stamping node 14 and uplink (UL) transmissions from the time-stamping node 14. The time-stamping node 14 may be a UPF of the 3GPP network, e.g., an anchor UPF exposing the Internet Protocol (IP) address of the UE. The time-stamping node 14 may be a distributed node comprising a baseband unit and one or more remote radio units. The time-stamping node 14 may be a network node, e.g. a radio network node, providing e.g. radio coverage over a geographical area, a service area 15, e.g. one or more cells, of a RAT, such as NR, LTE, Wi-Fi, WiMAX or similar. The time-stamping node 14 may be a transmission and reception point, a computational server, a base station e.g. a network node such as a satellite, a WLAN access point or an AP STA, an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used.

The methods according to embodiments herein may be performed by the time-stamping node 14 or the intermediate node 12, respectively. As an alternative, a Distributed Node (DN) and functionality, e.g. comprised in the cloud 40 as shown in FIG. 1 may be used for performing or partly performing the methods.

According to embodiments herein the time-stamping node 14 provides an indication of a delivery time (DT) to a packet and transmits the packet with the DT towards an end-node in the communication network. The intermediate node 12 receives the packet comprising the DT and may subtract a latency value from the DT. The intermediate node 12 determines one or more transmission parameters based on the DT and transmits the packet with the DT towards an end-node in the communication network 1, based on the determined one or more transmission parameters.

An advantage that may be achieved with the embodiments herein is that a latency buffer that was reserved for but not needed by the time-stamping node 14 may instead be utilized for more efficient network usage.

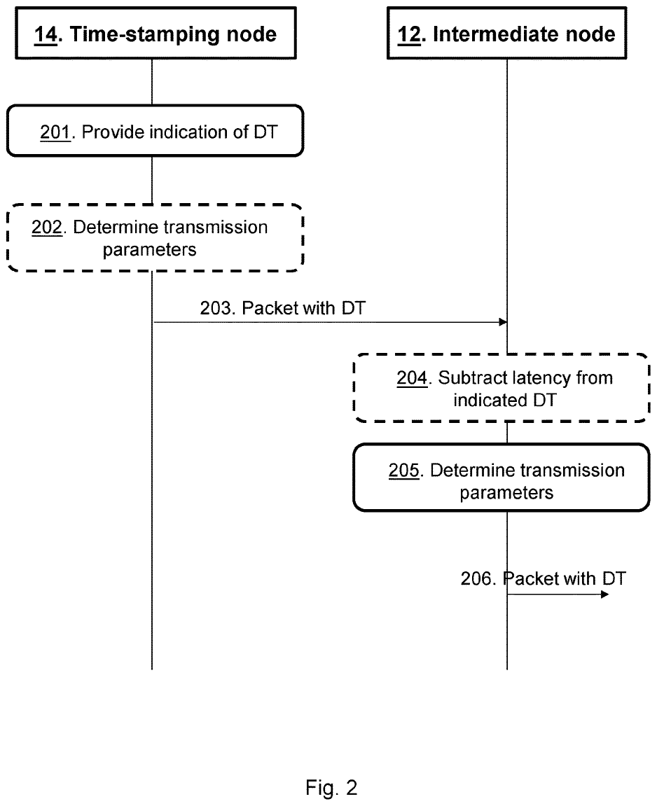

An example scenario of handling communication in the communication network 1, according to embodiments herein, will now be described with reference to FIG. 2. Dashed boxes indicate optional features. Embodiments herein relate to that the time-stamping node 14, which may be a network node, a UE, e.g. an application in a UE or an application on the network side (e.g., in a data centre), includes the DT explicitly in packets it sends towards an end-node. Each node, e.g. intermediate node 12, along the path subtracts the latency that it consumed. The DT comprises an indication of a remaining time budget until a delivery. The DT may be an absolute time. The time-stamping node 14 may thus set the DT and provide the DT together with the packet. The intermediate node 12 receives the packet and the DT, adapts its behaviour to the remaining delay and sends the packet onwards towards the final receiver. This may allow the application, or any node further in the UL and DL respectively to be the time-stamping node 14. A network node may in principle be both the time-stamping node 14 and the intermediate node 12. The time-stamping node may also adapt its behaviour to the remaining delay, e.g., if the UPF act as a time-stamping node. The time-stamping node 14 may not time-stamp all packets and the intermediate node 12 may be able to handle non-time-stamped packets.
Action 201. An estimate of link latency of links along the path after the time-stamping node's 14 link, i.e. rest of path latency, needs to be obtained. The time-stamping node 14 therefore provides the indication of the DT to the packet. Each packet gets an indication of the DT. The DT may thus vary between packets. E.g., the DT is extended with an earlier time point of reception/obtaining of the packet compared with an expected time point. The time-stamping node 14 thus sets a delivery time, e.g. a delay budget and amend it to the packet in the various ways. The indication of the DT may be provided as a part of a protocol, e.g., as a header field or an information element in the protocol, or in a field of the packet. The DT may be provided as an absolute time with a known reference. The absolute time may be a Universal Time Coordinated (UTC).
Action 202. The time-stamping node 14 may determine, e.g. adapts, one or more transmission parameters based on the DT. This is e.g. for utilizing up to the available link budget. Determining transmission parameters when used herein may mean improving coding, using more resources, resending, queueing methods, prioritizing other packets, batching packets for more efficient resource usage, use of a remaining latency, etc.
Action 203. The time-stamping node 14 then transmits, e.g. sends, the packet with the DT towards an end-node in the communication network. The transmission may be based on the determined one or more transmission parameters. The time-stamping node 14 may be an end-node out of the two end-nodes, and the packet may be transmitted towards another end-node.
Action 204. The intermediate node 12 receives the packet, comprising the indication of DT. The intermediate node 12 may be a UE or a network node. The available link budget may need to be derived, therefore the intermediate node 12 may subtract the latency value from the indicated DT. The intermediate node 12 may decrement the DT by an amount of time that the packet was queued and/or processed in the intermediate node 12.
Action 205. The intermediate node 12 determines the one or more transmission parameters based on the DT. Determining the one or more transmission parameters based on the DT may comprise increasing a scheduling weight of packets with decreasing available time until their expected delivery to the end-node. Determining the one or more transmission parameters based on the DT may comprise decreasing a code rate for a transmission of packets with decreasing available time until their expected delivery to the end-node.
Action 206. The intermediate node 12 transmits the packet with the DT towards the end-node in the communication network 1. The transmission is based on the determined one or more transmission parameters. The end-node may be the time-stamping node 14, e.g. for the reverse direction, or a receiving node.

An advantage of embodiments herein may be that the actual latency that each node, e.g. intermediate node 12, along the path may spend increases compared to a worst-case latency budget.

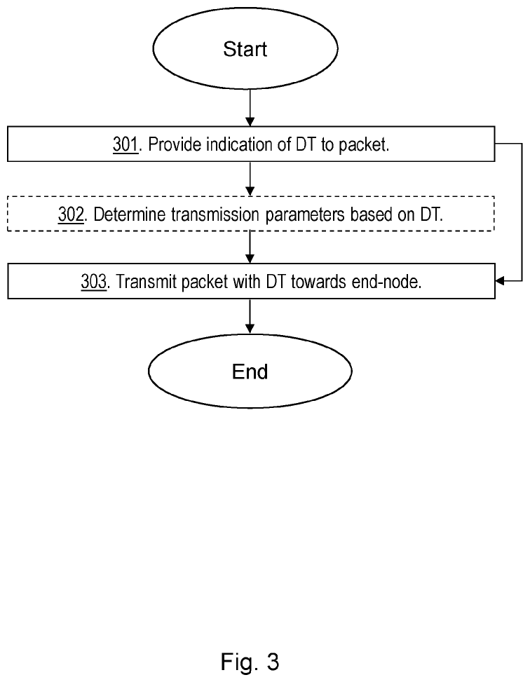

The method actions performed by the time-stamping node 14 for handling communication in the communication network 1, according to embodiments herein, will now be described with reference to a flowchart depicted in FIG. 3. The actions do not have to be taken in the order stated below but may be taken in any suitable order. Dashed boxes indicate optional features.
Action 301. The time-stamping node 14 provides the indication of the DT to the packet, wherein the DT is related to an upper latency limit of the packet along a path between two end-nodes. The DT may be provided as the absolute time with a known reference. The indication of the DT may comprise an indication of a remaining time budget until a delivery. The indication of the DT may be provided as a part of a protocol. The indication of the DT may be provided in a field of the packet. The time-stamping node 14 may be an end-node out of the two end-nodes, and wherein the packet may be transmitted towards another end-node. The time-stamping node 14 may be a UE or a network node.
Action 302. The time-stamping node 14 may determine the one or more transmission parameters based on the DT.
Action 303. The time-stamping node 14 transmits the packet with the DT towards an end-node in the communication network 1. The transmission may be based on the determined one or more transmission parameters.

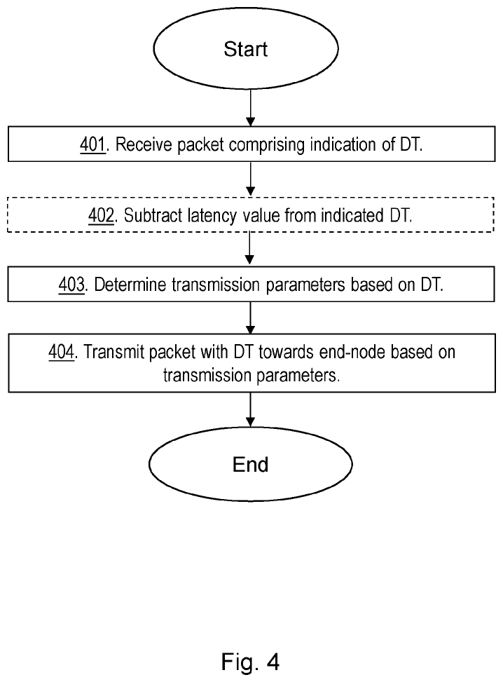

The method actions performed by the intermediate node 12 for handling communication in the communication network 1, according to embodiments herein, will now be described with reference to a flowchart depicted in FIG. 4. The actions do not have to be taken in the order stated below but may be taken in any suitable order. Dashed boxes indicate optional features.
Action 401. The intermediate node 12 receives the packet comprising the indication of the DT. The packet may be received from the time-stamping node 14 or a preceding intermediate node. The intermediate node 12 may be a UE, or a network node. The DT may be provided as an absolute time with a known reference.
Action 402. The intermediate node 12 may subtract the latency value from the indicated DT. According to some embodiments, subtracting the latency value may be based on a local clock of the intermediate node 12 and/or based on a passive link delay estimate. The intermediate node 12 may decrement the DT by the amount of time that the packet was queued and/or processed in the intermediate node 12.
Action 403. The intermediate node 12 determines the one or more transmission parameters based on the DT. The intermediate node 12 may determine the available time until an expected delivery time. Determining the one or more transmission parameters based on the DT may comprise increasing the scheduling weight of packets with decreasing available time until their expected delivery to the end-node. Determining the one or more transmission parameters based on the DT may comprise decreasing the code rate for a transmission of packets with decreasing available time until their expected delivery to the end-node.
Action 404. The intermediate node 12 transmits the packet with the DT towards the end-node in the communication network 1, based on the determined one or more transmission parameters.

Embodiments herein such as mentioned above will now be further described and exemplified. The text below is applicable to and may be combined with any suitable embodiment described above. The application, e.g. in UE, may need to provide latency relaxation information for every sent message. This may be the DT. This may also be considered to be a latency budget or in other words a relative deadline. It may be made to handle a full and/or partial network path between the end-nodes or it may be specific for only the RBS part. The RBS part when used herein means the radio link between the UE and the RBS. The packet with the DT may be provided as meta-data. It may also be provided as a part of a protocol, e.g., on top of the IP, between the application and the network. Introduction of a field with latency budget left, similar to Time To Live (TTL) in IP, where each node subtracts delay introduced, based on its local clock and passive link delay estimates. Mapping of this DT field, or PDB field, may be needed from IP to 3GPP protocols. This may then handle the latency in both Time Sensitive Networking (TSN)/Deterministic Networking (DetNet) and URLLC.

Optionally the idea may be extended over many links not only inside the RBS, since inside RBS the timing requirements of the steps are already known. By itself, only a rough idea of the remaining needed budget is known, but unless being the RBS, an understanding of the estimated time required by any remaining down-/up-stream nodes may be needed. E.g. if the DT, or PDB, has 5 ms remaining and there are 3 more network hops, it is useful to know what the deadline is to forward the packet. This option to the idea may be accomplished using TWAMP-like protocols, in a multi-hop approach along the path to the destination. This works like a traceroute, providing timing information to each hop, but very precisely. So, each node may estimate the latency of the remaining downlink path. Alternatively, Precision Time Protocol (PTP) besides precise clock synchronization may also estimate delay between nodes which may be utilized for calculating downstream nodes time budget, with the caveat that PTP usually may have a fast path in equipment that support it natively.

It may also be considered that when two UE communicate in a Peer-to-peer (P2P) fashion instead of server to UE, two RBSs may be involved.

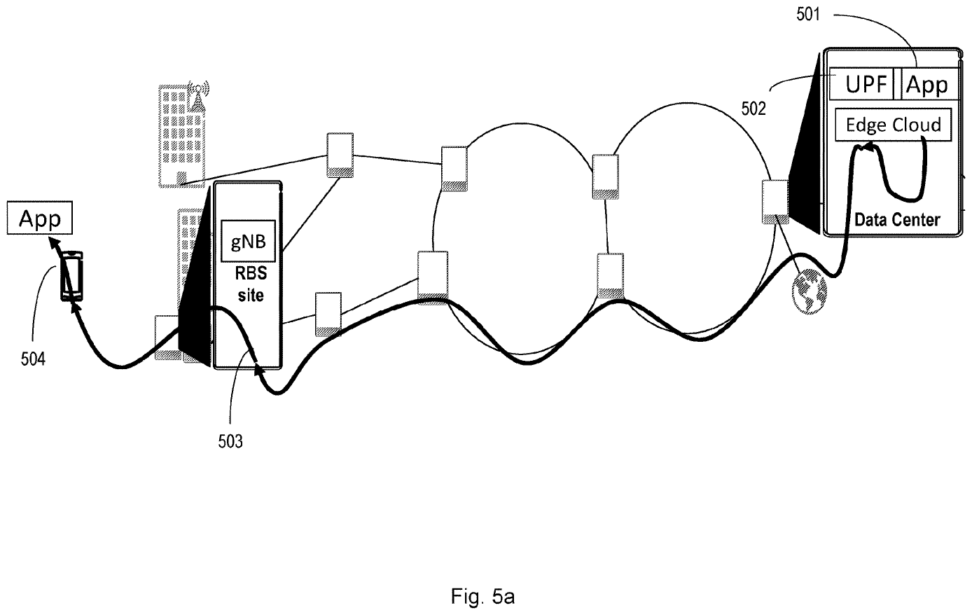

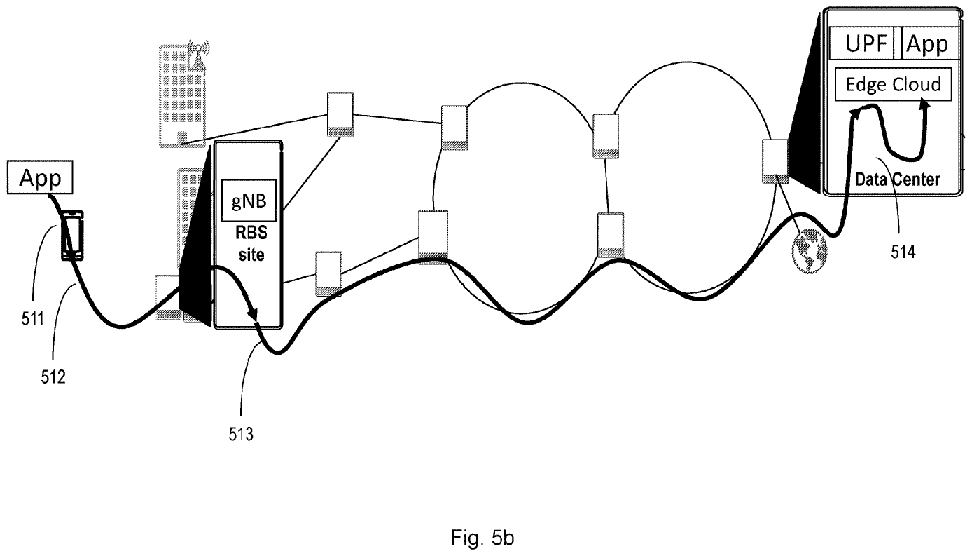

An example scenario of handling communication in the communication network 1, according to embodiments herein, will now be described with reference to FIGS. 5a and 5b. FIG. 5a illustrates handling of the delivery time in DL.
Action 501. The DT may be set by e.g. the application. The data packet with the DT is then sent towards the end node.
Action 502. The latency value may be subtracted from the DT, by e.g. the UPF, if the DT is the delay budget but not if it is the absolute time, and send the data packet with the DT.
Action 503. The intermediate node 12, e.g., gNB, may subtract the latency value from the DT, if the DT is the delay budget but not if it is the absolute time. The latency value may be an estimate of the time used since the previous node sent the packet with the DT, e.g., including its own queueing, processing, and the transport latency from the previous node. Transmission parameters may be selected, which may include queueing and the data packet with the DT may be sent.
Action 504. The intermediate node 12, e.g. the UE, then sends the data packet, with the DT.

FIG. 5b illustrates handling of the delivery time in UL.
Action 511. The time-stamping node 14, e.g. UE, sets the DT and sends the data packet with the DT.
Action 512. The latency value may be subtracted from the DT, by e.g. the intermediate node 12, if the DT is the delay budget, but not if it is the absolute time. The transmission parameters may be selected if possible. The data packet is then sent with the DT.
Action 513. The intermediate node 12, such as the gNB, may subtract the latency value from the DT if the DT is the delay budget, but not if it is the absolute time. The latency value may be an estimate of the time used since the previous node sent the packet with the DT, e.g., including its own queueing, processing, and the transport latency from the previous node. The intermediate node then sends the data packet with the DT.
Action 514. The latency value may be subtracted, e.g. by the intermediate node 12 such as the UPF, from the DT if the DT is the delay budget, but not if it is the absolute time. The data packet with the DT is then sent.

Note that, though the FIGS. 5a and 5b show the application client and server respectively as the time-stamping node 14 (by the behaviour “set the DT” and “provide the DT with the packet”), the time-stamping behaviour may be placed, e.g., with the next hop nodes (the UE and the UPF in UL and DL respectively).

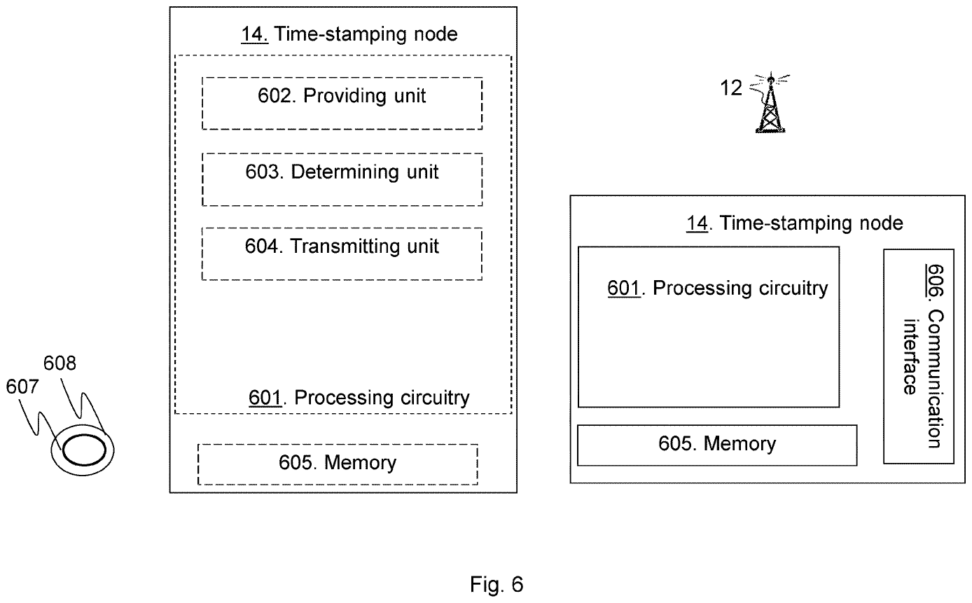

FIG. 6 is a block diagram depicting the time-stamping node 14 for handling communication in the communication network 1, according to embodiments herein.

The time-stamping node 14 may comprise processing circuitry 601, e.g. one or more processors, configured to perform the methods herein.

The time-stamping node 14 may comprise a providing unit 602. The time-stamping node 14, the processing circuitry 601, and/or the providing unit 602 is configured to provide the indication of the required DT to the packet, wherein the DT is related to an upper latency limit of the packet along a path between two end-nodes. The indication of the DT may comprise the indication of a remaining time budget until a delivery. The DT may be provided as the absolute time with a known reference. The indication of the DT may be provided as the part of a protocol. The indication of the DT may be provided in the field of the packet. The time-stamping node 14 may be the end-node out of the two end-nodes, and wherein the packet may be transmitted towards another end-node. The time-stamping node 14 may be the UE or the network node.

The time-stamping node 14 may comprise a determining unit 603. The time-stamping node 14, the processing circuitry 601, and/or the determining unit 603 may be configured to determine the one or more transmission parameters based on the DT, wherein the packet is transmitted based on the determined one or more transmission parameters.

The time-stamping node 14 may comprise a transmitting unit 604. The time-stamping node 14, the processing circuitry 601, and/or the transmitting unit 604 is configured to transmit the packet with the DT towards the end-node in the communication network 1.

The time-stamping node 14 further comprises a memory 605. The memory 605 comprises one or more units to be used to store data on, such as transmission parameters, packets, PDBs, latency buffer values, latency information, input/output data, metadata, etc. and applications to perform the method disclosed herein when being executed, and similar. The time-stamping node 14 may further comprise a communication interface 606 comprising e.g. a transmitter, a receiver, a transceiver and/or one or more antenna or antenna elements.

The method according to the embodiments described herein for the time-stamping node 14 is implemented by means of e.g. a computer program product 607 or a computer program, comprising instructions, i.e., software code portions, which, when executed on at least one processor, cause the at least one processor to carry out the actions described herein, as performed by the time-stamping node 14. The computer program product 607 may be stored on a computer-readable storage medium 608, e.g. a disc, a universal serial bus (USB) stick or similar. The computer-readable storage medium 608, having stored thereon the computer program product, may comprise the instructions which, when executed on at least one processor, cause the at least one processor to carry out the actions described herein, as performed by the time-stamping node 14. In some embodiments, the computer-readable storage medium may be a transitory or a non-transitory computer-readable storage medium.

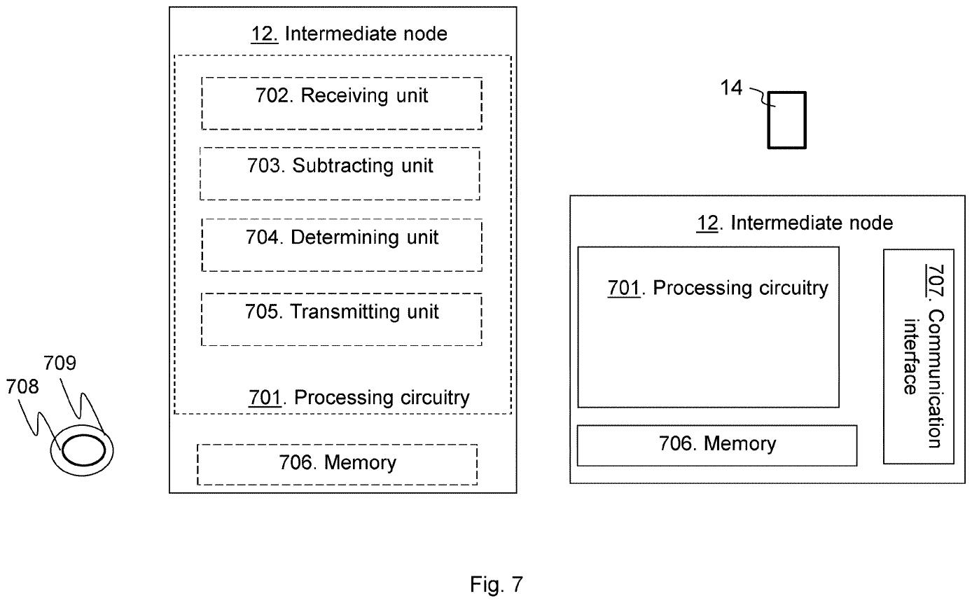

FIG. 7 is a block diagram depicting the intermediate node 12 for handling communication in the communication network 1, according to embodiments herein.

The intermediate node 12 may comprise processing circuitry 701, e.g. one or more processors, configured to perform the methods herein.

The intermediate node 12 may comprise a receiving unit 702. The intermediate node 12, the processing circuitry 701, and/or the receiving unit 702 is configured to receive the packet comprising the DT. The DT may be provided as the absolute time with a known reference. The intermediate node 12 may be the UE or the network node.

The intermediate node 12 may comprise a subtracting unit 703. The intermediate node 12, the processing circuitry 701, and/or the subtracting unit 703 may be configured to subtract the latency value from the DT. The intermediate node 12 may decrement the DT by an amount of time that the packet was queued and/or processed in the intermediate node. Subtracting the latency value may be based on the local clock of the intermediate node 12 and/or based on the passive link delay estimate.

The intermediate node 12 may comprise a determining unit 704. The intermediate node 12, the processing circuitry 701, and/or the determining unit 704 is configured to determine the one or more transmission parameters based on the DT. The intermediate node 12 may determine the available time until the expected delivery time. Determining the one or more transmission parameters based on the DT may comprise increasing the scheduling weight of packets with decreasing available time until their expected delivery to the end-node. Determining the one or more transmission parameters based on the DT may comprise decreasing the code rate for the transmission of packets with decreasing available time until their expected delivery to the end-node.

The intermediate node 12 may comprise a transmitting unit 705. The intermediate node 12, the processing circuitry 701, and/or the transmitting unit 705 is configured to transmit the packet with the DT towards the end-node in the communication network 1, based on the determined one or more transmission parameters.

The intermediate node 12 further comprises a memory 706. The memory 706 comprises one or more units to be used to store data on, such as transmission parameters, packets, PDBs, latency buffer values, latency information, input/output data, metadata, etc. and applications to perform the method disclosed herein when being executed, and similar. The intermediate node 12 may further comprise a communication interface 707 comprising e.g. a transmitter, a receiver, a transceiver and/or one or more antenna or antenna elements.

The method according to the embodiments described herein for the intermediate node 12 is implemented by means of e.g. a computer program product 708 or a computer program, comprising instructions, i.e., software code portions, which, when executed on at least one processor, cause the at least one processor to carry out the actions described herein, as performed by the intermediate node 12. The computer program product 708 may be stored on a computer-readable storage medium 709, e.g. a disc, a universal serial bus (USB) stick or similar. The computer-readable storage medium 709, having stored thereon the computer program product, may comprise the instructions which, when executed on at least one processor, cause the at least one processor to carry out the actions described herein, as performed by the intermediate node 12. In some embodiments, the computer-readable storage medium may be a transitory or a non-transitory computer-readable storage medium.

In some embodiments the general term “network node” is used and it can correspond to any type of radio-network node or any network node, which communicates with a wireless device and/or with another network node. Examples of network nodes are gNodeB, eNodeB, NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or UE is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the devices receives and/or transmit signals, e.g. data, such as NR, Wi-Fi, LTE, LTE-Advanced, WCDMA, Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a UE or network node, for example.

Alternatively, several of the functional elements of the processing units discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as Read-Only Memory (ROM), Random-Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

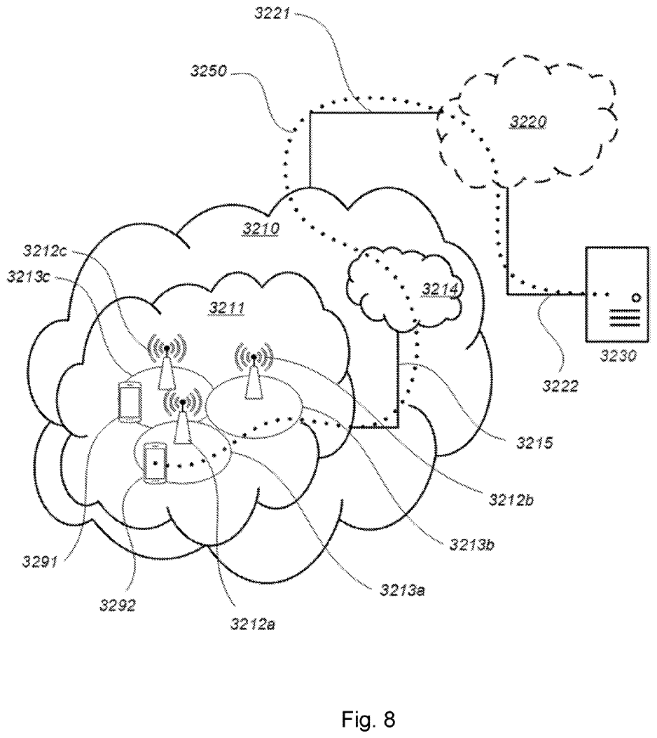

With reference to FIG. 8, in accordance with an embodiment, a communication system includes a telecommunication network 3210 such as the wireless communications network 100, e.g. a NR network, such as a 3GPP-type cellular network, which comprises an access network 3211, such as a radio access network, and a core network 3214. The access network 3211 comprises a plurality of base stations 3212a, 3212b, 3212c, such as the radio network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless devices 120 such as a Non-AP STA 3291 located in coverage area 3213c is configured to wirelessly connect to, or be paged by, the corresponding base station 3212c. A second UE 3292 e.g. the first or second radio node 110, 120 or such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

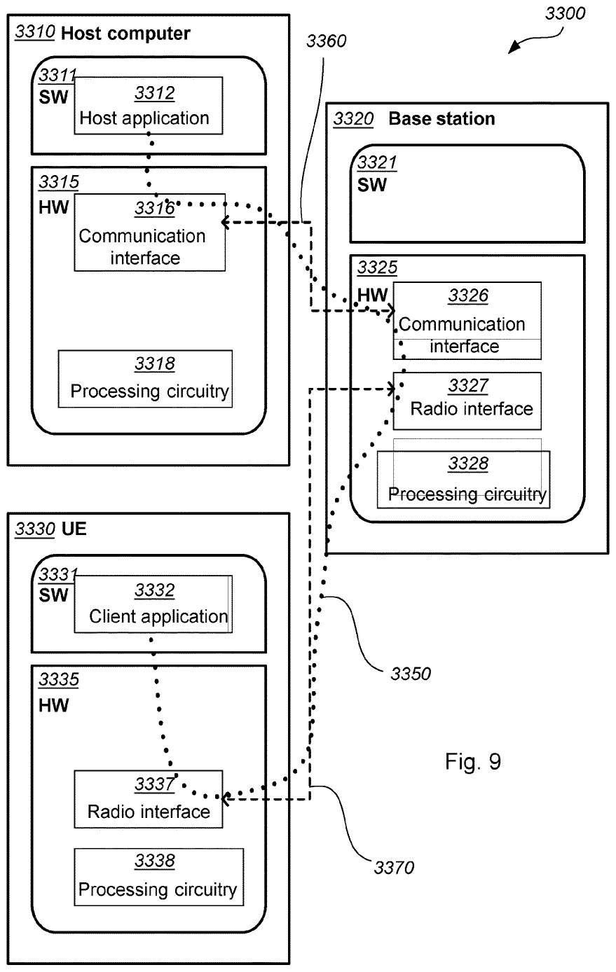

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

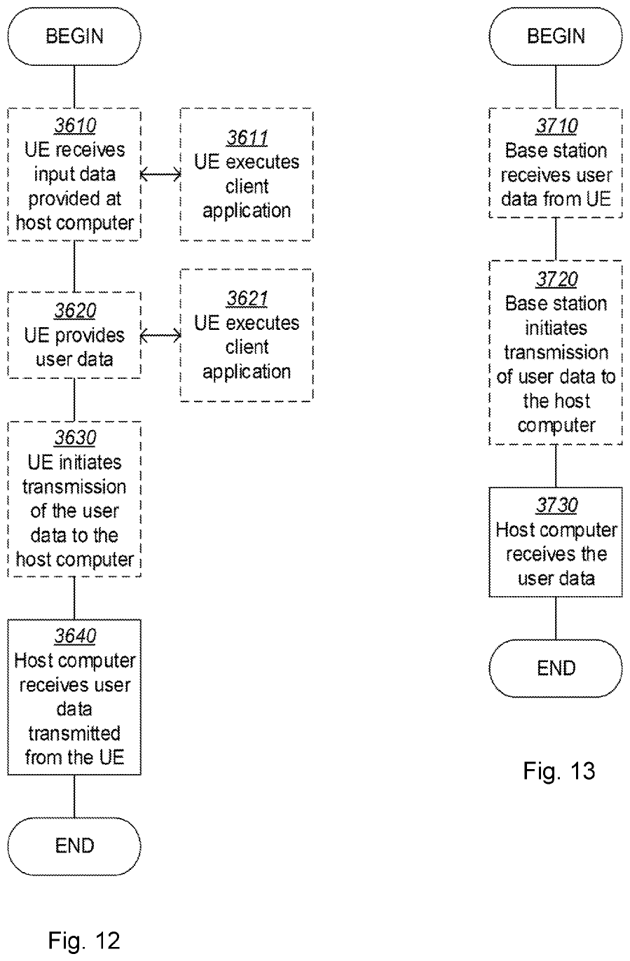

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 12) served by the base station 3320. The communication interface 3326 may be configured to facilitate a connection 3360 to the host computer 3310. The connection 3360 may be direct or it may pass through a core network (not shown in FIG. 12) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 8, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may decrease the handover latency and thereby improve the communication in the communication network for the UE. This may also lead to extended battery lifetime of the UE.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

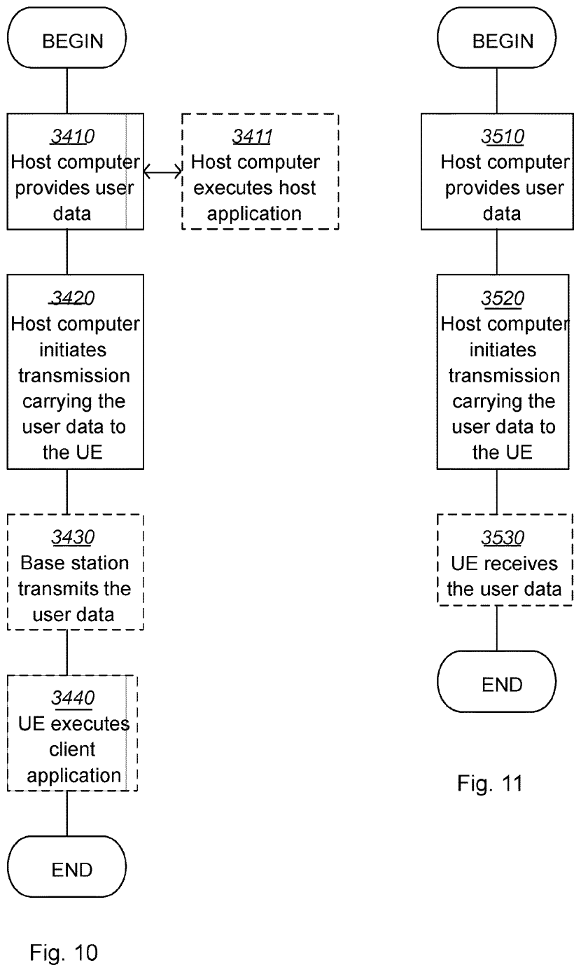

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 10 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 11 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 12 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 13 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a time-stamping node for handling communication in a communication network, the method comprising:
providing an indication of a required delivery time, DT, to a packet, the DT being related to an upper latency limit of the packet along a path between two end-nodes; and
transmitting the packet with the DT towards an end-node in the communication network.

2. The method according to claim 1, further comprising:
determining one or more transmission parameters based on the DT, wherein the packet is transmitted based on the determined one or more transmission parameters.

3. The method according to claim 1, wherein the indication of the DT comprises an indication of a remaining time budget until a delivery.

4. The method according to claim 1, wherein the DT is provided one of both of as an absolute time with a known reference and as a part of a protocol.

5. (canceled)

6. The method according to claim 1, wherein the indication of the DT is provided in a field of the packet.

7. The method according to claim 1, wherein one or both:
the time-stamping node is an end-node out of the two end-nodes, and wherein the packet is transmitted towards another end-node; and
the time-stamping node is a user equipment or a network node.

8. (canceled)

9. A method performed by an intermediate node for handling communication in a communication network, the method comprising:
receiving a packet comprising an indication of a required delivery time, DT;
determining one or more transmission parameters based on the DT; and
transmitting the packet with the DT towards an end-node in the communication network, based on the determined one or more transmission parameters.

10. The method according to claim 9, wherein the intermediate node decrements the DT by an amount of time that the packet was one or both queued and processed in the intermediate node.

11. The method according to claim 9, wherein the DT is provided as an absolute time with a known reference.

12. The method according to claim 9, further comprising:
subtracting a latency value from the indicated DT.

13. The method according to claim 12, wherein subtracting the latency value is based on a local clock of the intermediate node and/or based on a passive link delay estimate.

14. The method according to claim 9, wherein the intermediate node is a user equipment or a network node.

15. The method according to claim 9, wherein the intermediate node determines an available time until an expected delivery time.

16. The method according to claim 9, wherein determining the one or more transmission parameters based on the DT comprises one or both increasing a scheduling weight of packets with decreasing available time until their expected delivery to the end-node, and decreasing a code rate for a transmission of packets with decreasing available time until their expected delivery to the end-node.

17. (canceled)

18. A time-stamping node for handling communication in a communication network, the time-stamping node being configured to:
provide an indication of a required delivery time, DT, to a packet, the DT being related to an upper latency limit of the packet along a path between two end-nodes; and
transmit the packet with the DT towards an end-node in the communication network.

19. The time-stamping node according to claim 18, wherein the time-stamping node is further configured to:
determine one or more transmission parameters based on the DT, wherein the packet is transmitted based on the determined one or more transmission parameters.

20. An intermediate node for handling communication in a communication network, the intermediate node being configured to:
receive a packet comprising an indication of a required delivery time, DT;
determine one or more transmission parameters based on the DT; and
transmit the packet with the DT towards an end-node in the communication network, based on the determined one or more transmission parameters.

21. The intermediate node according to claim 20, wherein the intermediate node is further configured to:
decrement the DT by an amount of time that the packet was one or both queued and processed in the intermediate node.

22. (canceled)

23. (canceled)

24. The time-stamping node according to claim 18, wherein the indication of the DT comprises an indication of a remaining time budget until a delivery.

25. The intermediate node according to claim 20, wherein the DT is provided as an absolute time with a known reference.
